(19) United States
(12) Patent Application Publication
(10) Pub. No.: US 2004/0017334 A1
(43) Pub. Date: Jan. 29, 2004

(54) Three-dimensional image display

(76) Inventor: Hau Man Chan, Hong Kong (HK)

Correspondence Address: JACKSON WALKER L.L.P., Suite 2100, 112 E. Pecan Street, San Antonio, TX, 78205, US

(21) Appl. No.: 10/205,799

(22) Filed: Jul. 26, 2002

(51) Int. Cl. G09G 5/00

(52) U.S. Cl. 345/6

(57) ABSTRACT

A three-dimensional image display includes a display screen, a projector operable to project two or more images onto the display screen sequentially, and a collimator located between the screen and a viewing position. The collimator is operable to change the viewing angle of the screen in sequence with the image projected onto the screen.

### BACKGROUND TO THE INVENTION

1. Field of the Invention

The invention relates to a three-dimensional image display.

2. Background Information

Three-dimensional images can be created, as already known, by arranging two or more images of different views of an object to be seen separately and simultaneously by an observer's two eyes. A variety of methods are known to achieve the three-dimensional effect. Two common methods are the use of special optical screens with a thin finely corrugated plastic overlay, and polarization which utilises the use of different viewing lenses for each eye.

The disadvantage with these known methods is that specialized equipment is required to manufacture the screens and/or lenses. Furthermore, with the use of special optical screens typically only small viewing areas are a possible. By contrast, the polarization method allows larger viewing areas however viewers are inconvenienced by the requirement to wear special viewing glasses.

### SUMMARY OF THE INVENTION

It is an object of the present invention to overcome or at least ameliorate the above-mentioned disadvantages, or at least to provide the public with a useful alternative.

According to a first aspect of the invention there is provided a three-dimensional image display including:

a display screen,

a projector, or projectors, operable to project two or more images onto the display screen sequentially, and

a collimator located between the screen and a viewing position and operable to change the viewing angle of the screen in sequence with the image projected onto the screen.

Preferably, the collimator includes a plurality of parallel vertical slats.

Preferably, the projector and the collimator are connected by a timing device.

Preferably, projector includes a rotatable disk having a light source at its centre and a plurality of slides arranged around its periphery, and one or more lenses disposed to lie linearly between the light source and the screen, and wherein rotation of the disk moves images sequentially between the light source and at least one lens.

Preferably, two images are displayed side-by-side simultaneously.

Preferably, display screen 14 is a liquid crystal display (LCD) and the projector is a computer or electronic system operable to transmit images to the liquid crystal display

Further aspects of the invention will become apparent from the following description, which is given by way of example only.

### BRIEF DESCRIPTION OF THE DRAWINGS

Embodiments of the invention will now be described with reference to the accompanying drawings in which:

FIG. 1 illustrates a first particular embodiment of the invention,

FIG. 2 illustrates the sequential images for the embodiment in FIG. 1,

FIG. 3 illustrates a section of a collimator for the embodiment in FIG. 1,

FIG. 4 illustrates a sequence of collimator positions for the images in FIG. 2, FIG. 5 illustrates a second particular embodiment of the invention,

FIG. 6 illustrates viewing positions for the embodiment in FIG. 5,

FIG. 7 illustrates a third particular embodiment of the invention,

FIG. 8 illustrates a collimator arrangement for the third particular embodiment,

FIG. 9 illustrates movement of the collimator arrangement,

FIG. 10 illustrates mirrors for the third particular embodiment, and

FIG. 11 illustrates an alternative embodiment for movement of the collimator.

### DESCRIPTION OF THE PREFERRED EMBODIMENTS

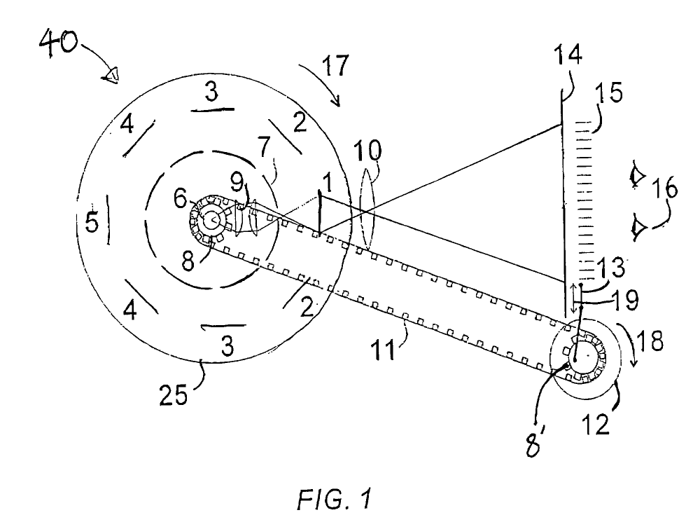

In the drawings like reference numerals refer to like integers. FIG. 1 illustrates a first, preferred, embodiment of the invention comprising a projector 40, a display screen 14 and a collimator 15. The projector 40 is a rear projection type and projects and image onto screen 14 to be viewed from a viewing position 16 on the opposite side of screen 14. The collimator 15 is located between the viewing position 16 and screen 14 and is operable to control of the viewing angle for screen 14.

Projector 40 includes a disk 25 with a light source 6 at its centre. A plurality of image slides 1,2,3,4,5, bearing a plurality of images, are disposed around the periphery of disk 25. A first pair of lens 9 focus light from the light source 6 through the image slides 1,2,3,4,5. A second lens 10 focuses the light from image slides 1,2,3,4,5 onto the rear of screen 14.

Disk 25 is arranged to rotate so that image slides 1,2,3,4,5 passes sequentially between the light source and lenses and are projected onto the back of screen 14. A circular shutter 7 with a plurality of apertures controls the light source during the transition between individual image slides 1,2,3,4,5. In an alternative embodiment shutter 7 is stationary with a single aperture, with light source 6 being controlled accordingly.

In yet a further embodiment light source 6 and shutter 7 are replaced by a stroboscopic light with bright, short pulse that freeze the image projected from a moving slide. It is operated in a way that shutter 7 opens or stroboscopic light flashes whenever the slides move to a position that is in line with the light source and the screen.

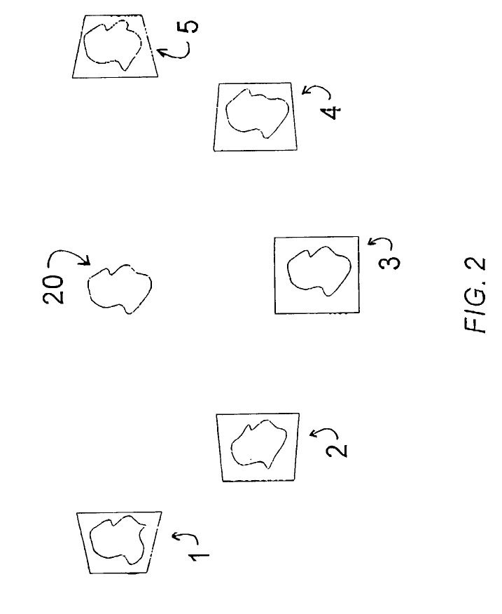

It will be appreciated by a person skilled in the art that in order for a 3D image to be projected, each of the image slides 1,2,3,4,5 must contain an image of an object taken from a different angle. When the separate images are viewed by different eyes of the Observer at a high frequency, above 25 images per second, the object will appear in 3D without flicker. FIG. 2 illustrates an object 20 and the images 1,2,3,4,5 taken of the object from different angles. These images are represented on the image slides.

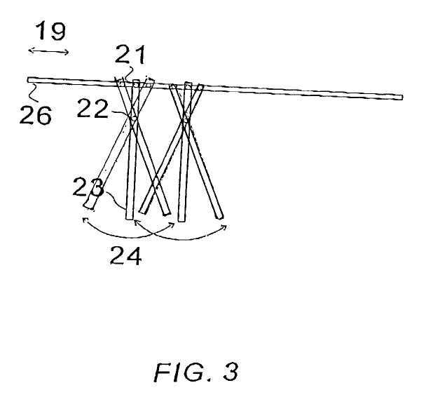

The collimator 15 controls viewing of the individual image slides 1,2,3,4,5 by the different eyes of the Observer. Referring to FIG. 3, thereshown is a section of the collimator 15. The collimator 15 comprises plurality of parallel slats 23 each mounted about a pivot 22. Each slat 23 is pivotally connected, at its distal end 21, to a control rod 26. Longitudinal movement, as indicated by arrow 19, of control rod 26 pivotally moves slats 23 as shown by arc 24.

Referring back to FIG. 1, control rod 26 is driven by a linkage 13 from a crank wheel 12. A toothed wheel 8 mounted on each of disk 25 and crank wheel 12 are connected by a toothed belt 11 to provide timing between rotation of disk 25, and thus the image displayed on screen 14, and movement of collimator 15 slats 23.

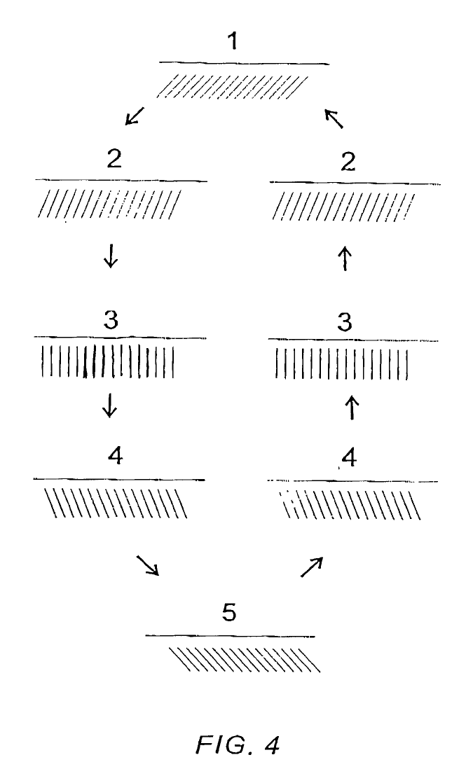

Referring to FIG. 4, thereshown are the different positions of collimator 15 for each of the images 1,2, 3,4,5. The collimator 15 provides that each image in only viewable from a specific viewing angle so that the observer's eyes see different images. The projector 40 is arranged to project more than 25 images per second so that the transition between images is invisible to the observer. The observer sees object 20 in 3D.

FIG. 5 illustrates a second particular embodiment of the invention. In this embodiment there are five projectors 40 for projecting the five images 1,2,3,4,5 onto the back of screen 14. It will be appreciated by the skilled addressee that more or less images can be projected using more or less (n) projectors 40. Each projector projects an image of the object taken from a different angle of view.

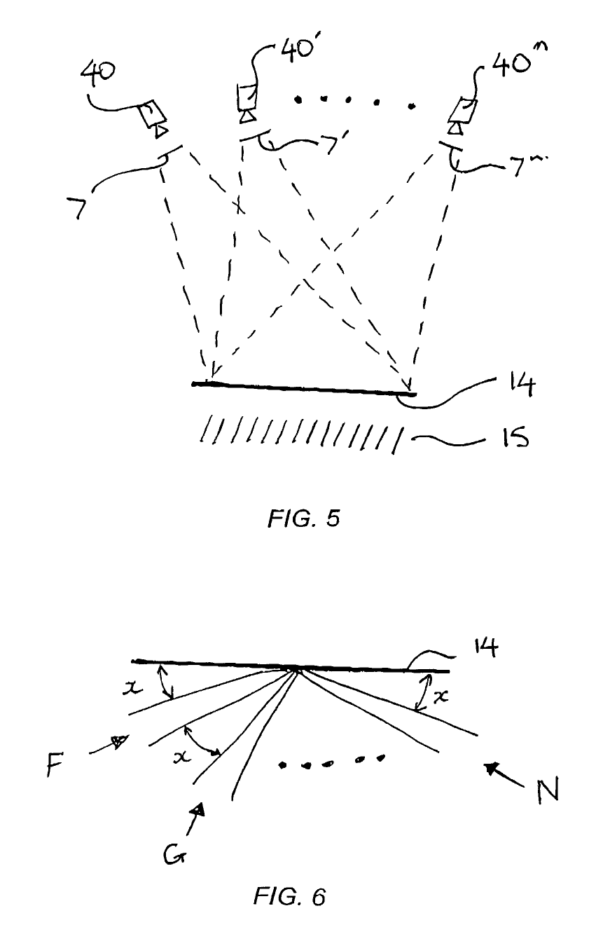

All projectors in the second particular embodiment operate all of the time. Each projector has an associated shutter 7 in front of its lens. The shutters 7 are operated in synchronisation with collimator 15 so that the desired image is projected for the required viewing angle. FIG. 6 illustrates the association of viewing angle with the images. During a transition Time x no image is viewable. When the collimator 15 is in a position for viewing from first position F first shutter 7 opens to allow the image from first projector 40 to be displayed on screen 14. When the collimator 15 is in a position for viewing from second position G second shutter 7′ is open to allow the image from second projector 40′ to be displayed on screen 14. The sequence continues until the collimator 15 is in a is position for viewing from position N and the n^{th} shutter 7ⁿ opens to allow the image from n^{th} projector 40″ to be displayed on screen 14.

Other methods of projecting multiple images onto screen 14 to coincide with the collimator 15 position will be apparent to the skilled addressee. One such other method includes the use of mirrors and lenses.

In yet another embodiment screen 14 is a liquid crystal display (LCD) and the projector is a computer or electronic system operable to transmit images to the liquid crystal display, The computer or electronic system also controls the collimator 15 by way of actuators, stepper motors or the like to synchronise the image displayed and collimator 15 position,

The above mentioned embodiments use a projector type display, however more common types of display such as CRT and LCD displays (as found in television set and computer monitors) can be used.

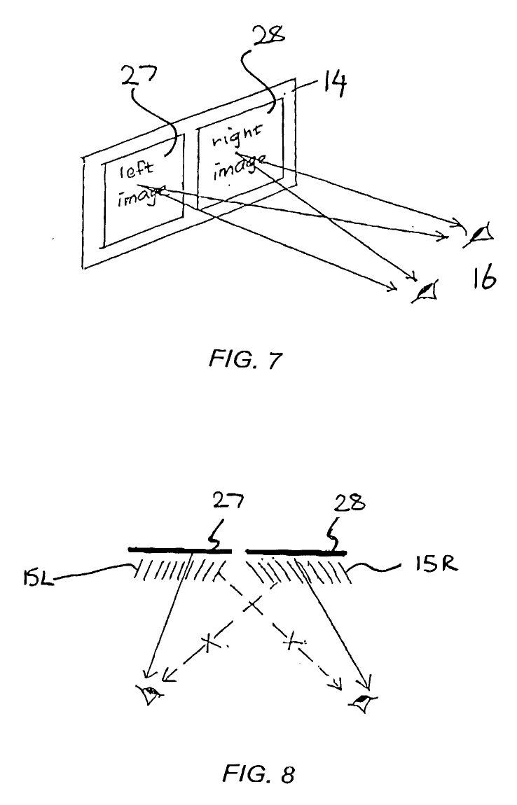

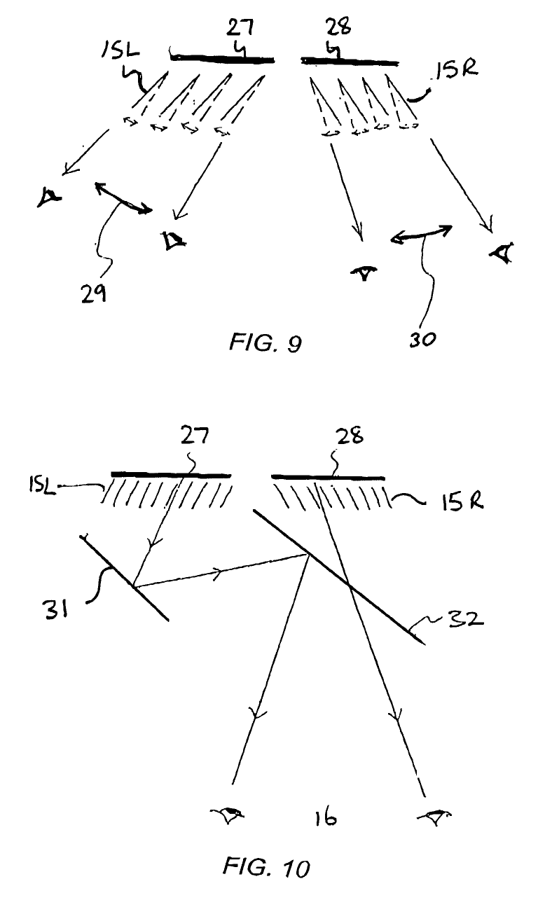

FIG. 7 shows a third embodiment of the invention where images 27, 28 for right and left eyes are displayed side-by-side on the display screen 14. This will not give viewer 16 3D effect because both images 27, 28 are exposed to both left and right eyes. For 3D perception the right-eye has to receive the right-eye image 28 only while the left-eye has to receive the left-eye image 27 only. To achieve this, installation of the two collimators 15L, 15R are located in front of each image 27, 28 as shown in FIG. 8. Right collimator 15 helps to prevent the light from right image 28 reaching the left eye and left collimator 15L helps to prevent the light of left image 27 reaching the right eye. In order not to confine the images to be viewed only at specific angle of view, slats of both collimators 15L, 15R are allowed to flap within a certain range 29, 30 of angle shown in FIG. 9. It should be noted that no synchronization is required between two collimators 15L, 15R for this arrangement but the flapping frequency should be maintained above 25 Hz to avoid flicker.

The arrangement of the third embodiment will give a viewer 16 an uncomfortable feeling since two images 27, 28 do not come from the same position as they are arranged side-by-side. An auxiliary optical arrangement, installed to overcome this, is shown in FIG. 10. Left image 27 is reflected by a mirror 31 and allow a further reflection by partial mirror 32 to left eye. It will then appear as if the image 27 comes from the position of the right image 28. Right image 28 is allowed to pass through partial mirror 32 to reach the right eye. The final installation indicated in FIG. 10 helps to overlap the left and right images 27, 28 so that it appears as if they come from the same position.

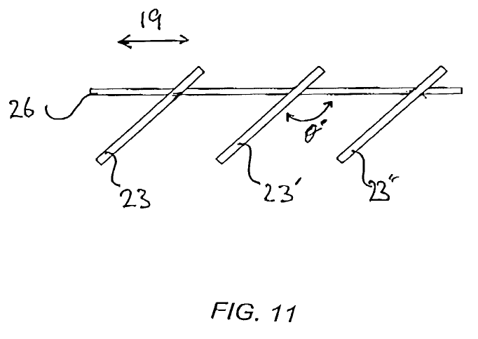

In the above-described embodiments the collimator 15 is a plurality of slats 23 arranged to a flap to-and-fro about pivot points 22 is illustrated by FIG. 3. In an alternative embodiment the collimator 15 may be arranged to oscillate side-to-side. FIG. 11 shows the alternative embodiment of the collimator 15 wherein in parallel slats 23 are mounted on control rod 26 and a fixed angle θ°. Longitudinal movement, as indicated by arrow 19, of control rod 26 moves slats 23 in a side-to-side oscillating motion. This oscillating motion has the benefit of reducing the blockage effect caused by the thickness of the slats 23 so that better visual quality can be achieved.

Where in the foregoing description reference has been made to integers or elements have known equivalents then such are included as if individually set forth herein.

Embodiments of the invention have been described, however it is understood that variations, improvement or modifications can take place without departure from the spirit of the invention or scope of the appended claims.

What is claim is:

1. A three-dimensional image display including:
a display screen,
projectors operable to project two or more images onto the display screen sequentially, and
a collimator located between the screen and a viewing position and operable to change the viewing angle of the screen in sequence with the image projected onto the screen.

2. A three-dimensional image display as claimed in claim 1 wherein the collimator includes a plurality of parallel vertical slats.

3. A three-dimensional image display as claimed in claim 2 wherein the slats flap to-and-fro about a pivot point, or of oscillate side-to-side at a fixed angle.

4. A three-dimensional image display as claimed in claim 1 wherein the projector and the collimator are connected by a timing device.

5. A three-dimensional image display as claimed in claim 1 wherein the projector includes a rotatable disk having a light source at its centre and a plurality of slides arranged around its periphery, and one or more lenses disposed to lie linearly between the light source and the screen, and wherein rotation of the disk moves images sequentially between the light source and at least one lens.

6. A three-dimensional image display as claimed in claim 1 wherein two images are displayed side-by-side simultaneously.

7. A three-dimensional image display as claimed in claim 1 wherein display screen 14 is a liquid crystal display (LCD) and the projector is a computer or electronic system operable to transmit images to the liquid crystal display

8. A three-dimensional image display including:
a display screen,
a projector comprising a rotatable disk having a light source at its centre and a plurality of image slides arranged around its periphery, and one or more lenses disposed to lie linearly between the light source and the screen, and
a collimator comprising a plurality of parallel vertical slats located between the screen and a viewing position, and wherein
rotation of the disk moves images sequentially between the light source and at least one lens while at the same time the collimator controls the viewing angle of the screen.
